(19) United States
(12) Patent Application Publication
(10) Pub. No.: US 2014/0379422 A1
(43) Pub. Date: Dec. 25, 2014

(54) INVENTORY PRICING BASED ON PRICE ELASTICITY DEMAND FROM MOVEMENT TRENDS

(71) Applicant: ADVANCED PRICING LOGIC, INC., Seal Beach, CA (US)

(72) Inventors: Dominique CHAPMAN, Seal Beach, CA (US); David H. LEONARD, Seal Beach, CA (US)

(21) Appl. No.: 13/922,040

(22) Filed: Jun. 19, 2013

(51) Int. Cl. G06Q 30/02

(52) U.S. Cl. CPC G06Q 30/0202; G06Q 30/0283
USPC 705/7.31

(57) ABSTRACT

A method for selectively adjusting a price associated with an inventory stock keeping unit (SKU) is disclosed. Each of the inventory SKUs has associated therewith one or more sales transaction history records and an original price value. A numerical growth rate percentage and a growth trend corresponding to one of one or more classifications are derived for each retrieved inventory SKU. The classifications are based upon the sales transaction history records. Categorical price adjustment percentages for the one or more classifications of growth trends are received. An actual price adjustment percentage is assigned for predefined increments of the numerical growth rate percentages. A revised price value is generated for each of the inventory SKUs.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to electronic commerce, including inventory management, sales, and pricing therefor. More particularly, the present disclosure relates to automated inventory pricing based on price elasticity demand determined from movement trends.

2. Related Art

A key element to any business is the development and implementation of a successful pricing strategy. Seemingly a basic concept, the price for a given product offering must be high enough to meet the profitability and revenue goals of the seller to ensure its viability, while also being low enough for market acceptance such that the balance between production levels and demand remains optimal. Besides the profit maximization objective, pricing may be used to achieve quality leadership, cost recovery, and so forth. As a general matter, the perceived value to the customer, as well as the willingness and capacity to purchase, should be commensurate with the offered price. There may be additional variables relating to the realities of the marketplace, such as market position in relation to other competitors, the existence of other goods or services that are being sold, and importantly, demand elasticity of the particular goods or services being sold.

Various pricing strategies that attempt to meet the foregoing objectives and consider these variables and more are known in the art. At the most basic level, cost-plus pricing involves calculating the cost of producing the product, and adding on a profit margin thereto, regardless of purchasing volume. Some prices may be adjusted over time as a matter of course due to external factors such as increases in production costs, raw material costs, other supplier costs, and transportation costs, inflation, deflation, etc. Strategies based upon competitors' prices are also known in the art. The seller may opt to lower the price of a product in relation to a competitor if there is little or no other distinction in the kind of quality of the product, also referred to as economy pricing. On the other hand, the seller may raise the price of the product if there are substantial positive differentiators over competitors.

Prices are oftentimes discounted to improve sales volume and profits, or to encourage sales of a particular product, and underlying this strategy is the price elasticity of demand, or the responsiveness of the quantity demanded to a change in price. This may be specified in terms of a percentage change in quantity demanded in response to a 1% change in price, and each good in the inventory of one seller may have a different value, and may not necessarily be constant across the entire possible price range. However, it may be similar across comparable goods sold under comparable circumstances. Generally, price elasticity of demand depends on the availability of substitutes, the percentage of income that purchase would represent, the necessity of the good, brand loyalty, and who actually pays.

With the exception of anomalies such as Veblen goods and Giffen goods that exhibit a positive price elasticity of demand (where an increase in price results in an increase in demand), most goods have negative E_{d} values. When price elasticity of demand is zero, it is said to be perfectly inelastic, where changes in price do not affect quantity demanded. Hence, a raise in prices results in increased revenue. When between −1 and zero, it is relatively inelastic, and the percentage change in quantity demanded is smaller than that in price. Accordingly, as price is raised, revenue also increases, but not as much as with a price elasticity demand of zero. With a value of −1, or unit elastic, the percentage change in quantity demanded is equal to that in price. Hence, a 1% increase in price can be expected to yield a 1% decrease in demand. A price elasticity of demand less than −1 but greater than negative infinity is understood to be relatively elastic, so a percentage change in quantity demanded is greater than that in price. Thus, for such relatively elastic goods, as the price is raised, revenue decreases. When the price elasticity of demand is negative infinity, that is, perfectly elastic, any increase in price, no matter how small, results in demand dropping to zero. This is typical of goods that have values defined by law, for example.

Pricing strategy is dynamic and requires constant adjustment to market conditions. Although earlier methodologies for re-pricing entire an entire inventory of stock keeping units (SKUs) involved cumbersome manual procedures, several automated pricing systems have been developed. Analytics employing past sales data of various SKUs have been incorporated, with pricing adjustments being made based thereon.

Whenever pricing adjustments are made, it is important to consider the effects on demand, and how that change in demand and price together affects overall revenue. Accordingly, for these reasons and more, there is a need in the art for inventory pricing based on price elasticity of demand. There is also a need for such methods to utilize data already available to the seller, including movement trends and historical sales figures on a per-SKU basis.

### BRIEF SUMMARY

In accordance with one embodiment of the present disclosure, a method for selectively adjusting a price associated with an inventory stock keeping unit (SKU) is contemplated. The inventory SKU may be stored in a catalog database of a plurality of inventory SKUs. The method may include retrieving at least a subset of the plurality of inventory SKUs in the catalog database. Each of the retrieved inventory SKUs may have associated therewith one or more sales transaction history records and an original price value. There may be a step of deriving a numerical growth rate percentage and a growth trend corresponding to one of one or more classifications. These values may be derived for each retrieved inventory SKU. The classifications may be based upon the retrieved sales transaction history records. Additionally, there may be a step of receiving categorical price adjustment percentages for the one or more classifications of growth trends. Then, the method may include assigning an actual price adjustment percentage for predefined increments of the numerical growth rate percentages derived for each of the inventory SKUs. There may further be a step of generating a revised price value for each of the inventory SKUs. The generated revised price value may be based upon the corresponding actual price adjustment percentage for the associated numerical growth rate percentage thereof.

In another embodiment, the method may also include assigning each of the retrieved inventory SKUs to a one of a plurality of first predefined elasticity influence categories based upon associated first elasticity influence values. Each of the predefined first elasticity influence categories may have a corresponding first price adjustment percentage. The method may also include deriving price change values between the original price value and the revised price value for each of the retrieved inventory SKUs. Thereafter, there may be a step of generating an adjusted price change for each of the retrieved inventory SKUs. This may be achieved by applying a corresponding aggregate price adjustment percentage, including the first price adjustment percentage, to the price change values. The method may further include generating a second revised price value for each of the inventory SKUs based upon the corresponding adjusted price change.

Certain other embodiments of the present disclosure contemplate respective computer-readable program storage media that each tangibly embodies one or more programs of instructions executable by a data processing device to perform the foregoing method. The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an exemplary environment in which various embodiments of the presently contemplated method for selectively adjusting a price may be implemented;

FIG. 2 is a diagram illustrating an example data structure of an inventory stock keeping unit (SKU);

FIG. 3 is a flowchart of one exemplary method for selectively adjusting the price;

FIG. 4 is a table of sales data, adjustments, and forecast values arranged according to rows of SKUs;

FIG. 5 is a flowchart illustrating one implementation of deriving a growth trend in the method for selectively adjusting the price;

FIG. 6 is an exemplary screen capture of an elasticity influence configuration window in accordance with one embodiment of the present disclosure;

FIG. 7 is a table illustrating differing adjustment percentages that are to be applied depending on a selected smooth or precise transition; and

FIG. 8 is a table illustrating the application of adjustment percentages to prices.

Common reference numerals are used throughout the drawings and the detailed description to indicate the same elements.

### DETAILED DESCRIPTION

The present disclosure contemplates various methods for optimizing prices of an inventory of stock keeping units (SKUs). These methods involve price adjustments based on unit sales trends that are normalized for seasonality, mark-up rates, inventory days-on-hand levels, and SKU lead time metrics. Thus, prices can be rapidly adjusted to meet various market conditions while maximizing both revenue and sales volume.

The detailed description set forth below in connection with the appended drawings is intended as a description of the presently preferred embodiment of inventory re-pricing methods using price elasticity of demand, and is not intended to represent the only form in which the present disclosure may be developed or utilized. The description sets forth the functions and the sequence of steps for the development and operation of the illustrated embodiment. It is to be understood, however, that the same or equivalent functions and sequences may be accomplished by different embodiments that are also intended to be encompassed within the scope of the present disclosure. It is further understood that the use of relational terms such as first, second, and the like are used solely to distinguish one from another entity without necessarily requiring or implying any actual such relationship or order between such entities.

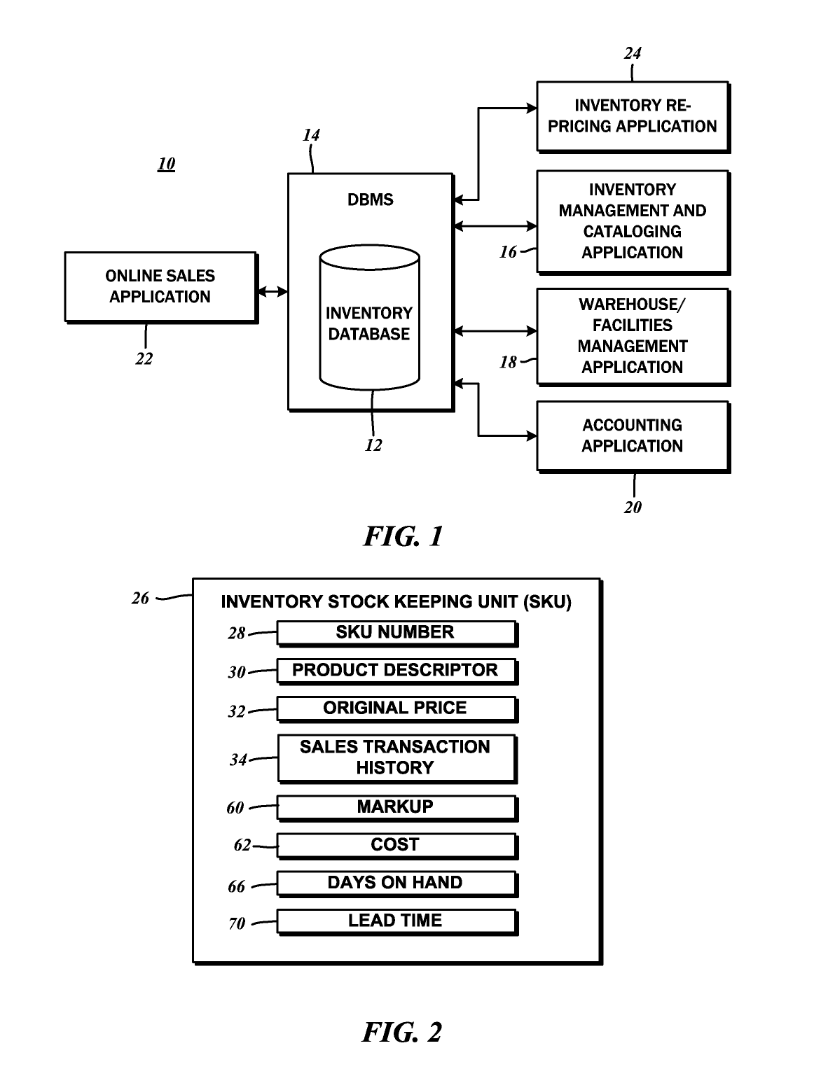

With reference to the block diagram of FIG. 1, the contemplated methods for selective re-pricing may be implemented in an enterprise resource planning (ERP) system 10 that, among other functions, manages the inventory of products that are being sold by a particular retailer. The details of the retailer's inventory are stored in an inventory database 12, and include various data fields that will be considered more fully below. A database management system (DBMS) application 14 may provide an interface to the inventory database 12 that receives queries from various external components and generates responses thereto. By way of example, the database management system application 14 may be a Structured Query Language (SQL) server.

The ERP system 10 may include numerous components that interface with the inventory database 12 to utilize the data stored thereon. Among these is inventory management/cataloging application 16, through which the retailer updates the inventory database 12 with new stocked products, remove products that are no longer carried, update some pricing, and so forth. Additionally, there may be a warehouse or facilities management application 18 that is utilized for order fulfillment and physical tracking of inventory. An accounting application 20 may access the inventory database 12 to tally the total number of sales for reporting, auditing, and other purposes. Online retailers may have a separate web server application 22 that communicates with the inventory database 12 to take and direct the fulfillment of customer orders. In accordance with the present disclosure, there is an inventory re-pricing application 24 that implements the contemplated methods.

Other aspects of the retailer's operation besides those expressly illustrated herein are managed by the ERP system 10, and those mentioned are presented by way of example only and not of limitation. Along these lines, the block diagram of FIG. 1 is intended to illustrate the logical or functional subparts of the ERP system 10, and not to limit the functionality associated therewith to any specific hardware or software component. For example, each of the aforementioned components may be a separate module running under an integrated ERP platform such as InOrder® from Morse Data of Dover, N.H., or SAP® ERP from SAP AG of Waldorf, Germany. Other, more industry-specific platforms with functionality limited to inventory management, and are offered as off-the-shelf products are also contemplated. Each of these components may be running on a single server computer hardware device including, in its most basic form, a processor, random access memory, and a permanent storage device. To the extent these components are accessed from other computer systems, there may also be associated network communications devices. Those skilled in the art will be capable of configuring the hardware systems tailored to the particular needs of the retailer.

The re-pricing application 24 that utilizes the contemplated elasticity-based methods may be Promoter® from Advanced Pricing Logic, Inc. of Seal Beach, Calif. Several related features thereof have been described in U.S. patent application Ser. No. 13/043,285 as well as U.S. patent application Ser. No. 13/540,360, both of the disclosures of which are incorporated by reference in their entireties herein. Generally, the inventory re-pricing application operates in conjunction with the inventory database management system application 14, and is therefore a standalone software application that performs one or more steps of the presently contemplated inventory re-pricing methods. The corresponding software instructions may be stored and executed on a computing device with a program storage medium readable thereby.

The inventory database 12 includes data fields in a table that store attributes of the products carried by the retailer. An individual entry in the inventory database 12 can also be viewed as a data object, with the inventory database 12 storing multiple ones of such data objects. FIG. 2 represents such a view, showing a single inventory SKU 26. Associated therewith is an SKU number 28 that is serves as a unique identifier for the product, and a product descriptor 30 that more fully describes item corresponding to the inventory SKU 26. Among other data, there is also an original price value 32, as well as one or more sales transaction history records 34.

According to one embodiment, the sales transaction history record 34 may be independent of the data object representing the inventory SKU 26 as shown, and so it may be a reference or pointer thereto. This data is understood to be stored in the ERP system 10, and may come in various forms. In some cases, the inventory SKU 26 may not contain the reference to the sales transaction history record 34, and each SKU may be referenced as pertaining to a particular sales transaction history record based upon its own SKU identifier. Those having ordinary skill in the art will recognize other suitable data structures without departing from the scope of the present disclosure. At the most detailed level, the sales transaction history record 34 may include an SKU identifier, a sale date, a sale quantity that corresponds to the sale date, and a quantity unit identifier for the sale quantity. Each of the sales made by the retailer will be so logged. Alternatively, and in accordance with a preferred, though optional embodiment, the sales transaction history record 34 may include aggregated summaries of sales for a particular SKU. In such case, there may likewise be an SKU identifier, a sale month, a sale year, a sale quantity summary for particular sale month and sale year, and a quantity unit identifier for the sale quantity summary. Three years of historical records is preferable, and retention of up to six years of rolling history may be optimal.

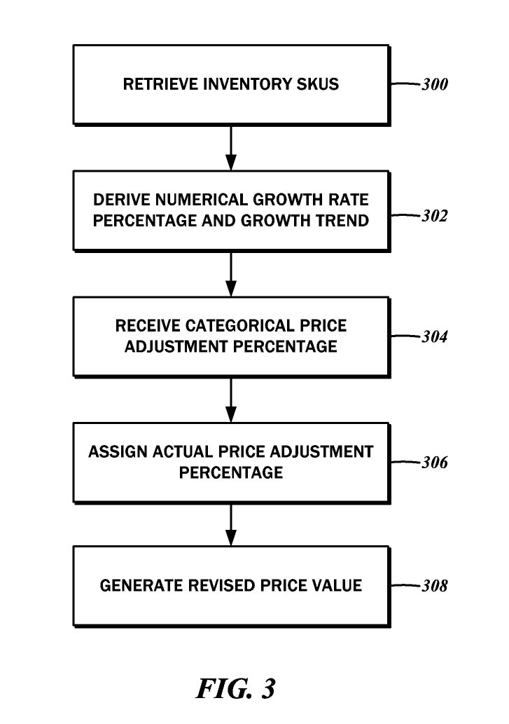

As indicated above, various embodiments of the present disclosure contemplate an elasticity-based inventory re-pricing method that supplements an existing re-pricing method based on other factors, and makes further adjustments and optimizations thereto. With reference to the flowchart of FIG. 3, the method for selectively adjusting a price may begin with a step 300 of retrieving at least a subset of the plurality of inventory SKUs 26 in the catalog or inventory database 12. Again, the inventory SKU is understood to have associated therewith one or more sales transaction history records 34 and the original price value 32.

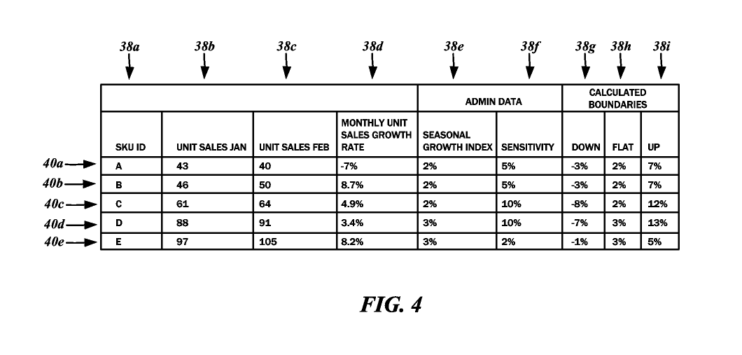

Generally, following the data retrieval step, the monthly unit sales growth trend for each of the retrieved SKUs is determined and normalized against the expected seasonal growth rate. Thus, it is possible to determine whether the particular growth rate of the SKU is due to seasonality or a legitimate trend up, down, or flat. More particularly, the method involves a step 302 of deriving, for each inventory SKU 26, a numerical growth rate percentage and a growth trend that corresponds to one or more classifications based on analyses of the corresponding sales transaction history records 34. As noted above, this data may be retrieved from the ERP system 10. In the embodiment where the sales transaction history records are summaries of monthly tallies, the numerical growth rate percentage is likewise understood to specify monthly growth. With reference to exemplary table 36 of FIG. 4, one implementation of deriving the numerical growth rate percentage involves retrieving the unit sales number for each SKU listed in column 38a for a first month as shown in column 38b, and for a second month as shown in column 38c. The growth rate is defined as the percentage of the units sold in the most recent month (the figures for the first month, of column 38b) over the units sold in the second most recent month (the figures for the second month, of column 38c). Column 38d lists the results of these calculations for each row 40a-40e of SKUs

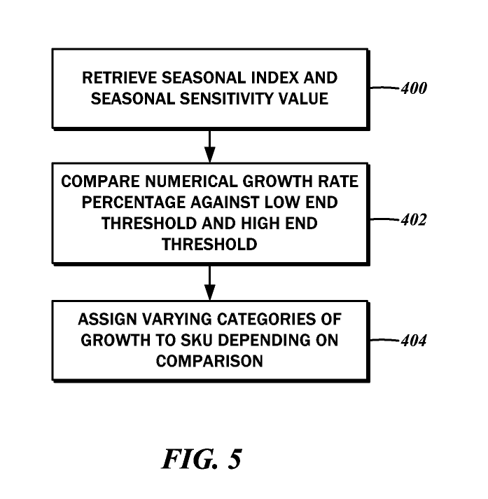

With the numerical growth rate being identified for each SKU, the growth trend is identified, as normalized against typical seasonality. In accordance with one embodiment, the growth trend may fall into one of a flat category, an up category, or a down category depending on the range in which the seasonally normalized numerical growth rate falls. Referring now to the flowchart of FIG. 5, additional details pertaining to the deriving of the growth trend will now be considered. There is a step 400 of retrieving a seasonal index and a seasonal sensitivity value specific to each inventory SKU 26. Exemplary values therefor are shown in column 38e and 38f, respectively, of the table 36 shown in FIG. 4. These may be retrieved from an external source and may be specified by the user on a per-SKU basis or on a per-category basis that covers multiple SKUs in a one-to-many relationship. The seasonal index value and the seasonal sensitivity value may be designated during configuration of the ERP system 10. However, it is also possible to generated seasonal index and seasonal sensitivity values from derived averages of prior sales data as well.

Many products, businesses, and industries exhibit seasonal growths and contractions over the course of the year, with all other variables being constant. It is also possible to specify total forecasts that span the entire year, and is understood to encompass the expected sales forecast that accounts for seasonality, as well as other factors that may increase sales beyond seasonal growths. In one example, the sale of ice cream is understood to increase significantly (sometimes as high as 50%) during the summer months, and is due to the seasonal demand for such snacks. Aside from the typical 50% increase, a particular seller may increase promotions for premium products, and with such increase, the seller may expect and additional 20% boost because of these promotions to 70%. The 50% expected increase is understood to be the seasonality growth, while the 70% expected increase with the increase promotions is understood to be the total forecast. On the other hand, it is also possible for additional promotions to offset expected drops due to seasonal contraction. In another example, sales of Christmas decorations may be expected to decline by at least 95% in January following the holiday season. If sales are noticeably slow during the month of December, and the retailer institutes a series of aggressive price cuts beyond typical post-season discounts in order to reduce high inventory levels, January sales may be slightly increased over the expected decline. For example, such efforts may result in a 10% benefit to sales, so rather than the expected −95% total forecast, it may be −85%. Thus, the seasonality growth forecast is understood to reflect the typical changes to sales, while the total forecast includes seasonality growth forecasts as well as accounting for other variables such as marketing campaigns, product introductions, strategic discounting, economic downturn, and so forth. As will be appreciated by those having ordinary skill in the art, any variances to seasonality growth forecasts affects pricing strategies, and variances in the total forecast may further reflect changed market conditions or that fundamental market assumptions were incorrect.

The seasonal growth index, shown in column 38e, is understood to represent the expected month over month growth rate that is attributable to seasonality. In one exemplary implementation, actual historical growth rates month over month can be calculated. If January growth is to be calculated, the difference between January unit sales and December unit sales is derived and expressed as a percentage value. With data for multiple years, average growth in any given month can be calculated, and may be utilized as the seasonal growth index.

The average variance in the seasonal growth index over multiple years of a given month, e.g., January 2011, January 2012, January 2103, etc. may correspond to the seasonal sensitivity value shown in column 38f. This value is understood to represent the maximum extent a unit growth percentage can vary as a result of the seasonal growth index, and still be considered a “flat” growth. In the first row 40a that shows the values for one SKU, it is indicated that the seasonal growth index is 2%, while the sensitivity is 5%, meaning that the seasonal growth index can vary between −3% (2%−5%) and 7% (2%+5%) yet be considered flat. For each row 40 or inventory SKU 26, the low end threshold, i.e., the seasonal sensitivity subtracted from the seasonal growth index, and the high end threshold, i.e., the seasonal sensitivity added to the seasonal growth index, are calculated. In the exemplary table 36, the low end threshold is included in column 38g and is considered the boundary between the flat growth trend and a decreasing growth trend. The seasonal growth index is reproduced in column 38h, and represents the flat growth trend. The high end threshold is included in column 38i, and is the boundary between the flat growth trend and an increasing growth trend.

Referring to the flowchart of FIG. 5, deriving the growth trend continues with a step 402 of comparing the numerical growth rate percentage (as included in column 38d) against the low end threshold and the high end threshold in columns 38g, 38i, respectively. In a step 404, varying categories of growth are assigned to the SKUs depending on the comparison of the corresponding numerical growth rate percentage to the aforementioned thresholds. More particularly, if the numerical growth rate percentage is greater than or equal to the high end threshold, an increasing growth trend classification is assigned. If the numerical growth rate percentage is less than or equal to the low end threshold, then a decreasing growth trend classification is assigned. If the numerical growth rate percentage falls between the low end threshold and the high end threshold, a flat growth trend classification is assigned. In the example shown, for the first row 40a or inventory SKU 26, the numerical growth rate is −7%, and because it is less than the low end threshold, e.g., −3%, a decreasing growth rate trend classification is assigned. Notwithstanding the specific disclosure of the foregoing, it is expressly contemplated that additional thresholds may be defined such as that which may correspond to a “slight” decrease or increase, “heavy” decrease or increase, and the like. In other words, more than three classifications can be assigned.

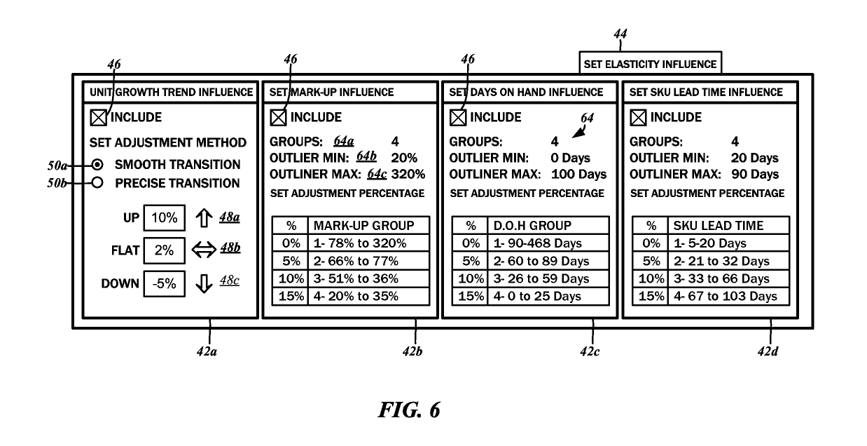

Referring again to the flowchart of FIG. 3, the method for selectively adjusting a price continues with a step 304 of receiving categorical price adjustment percentages for the one or more classifications of growth trends. That is, by way of example, an adjustment percentage for SKUs classified as having an increasing growth trend is received, as well as another adjustment percentage for SKUs classified as having a flat growth trend, and still another adjustment percentage for SKUs classified as having a decreasing growth trend. The screen capture of FIG. 6 illustrates a first interface panel 42a within an elasticity influence configuration window 38 by which the aforementioned data can be received from the user. As shown, the elasticity influence configuration user interface 44 includes other interface panels 42b-42d for mark-up influence, inventory days on hand influence, and SKU lead time influence, respectively. Details thereof and how the various adjustment percentages attendant thereto affect the final pricing will be considered more fully below. Each of the interface panels 42 includes an interface element that activates or deactivates that particular influence from the final pricing operation, and the first interface panel 42a thus includes a first checkbox 46.

In further detail, the first user interface also has a first text entry box 48a to specify the adjustment percentage for an increasing growth trend classification, a second text entry box 48b to specify the adjustment percentage for a flat growth trend classification, and a third text entry box 48c to specify the adjustment percentage for a decreasing growth trend classification. Rather than text entry boxes, other data input interfaces such as spinner boxes, pull-down menus and the like may be substituted, so usage of the term text entry box is by way of example only and not of limitation. In order to prevent unusual pricing results that may be difficult to correct later, there is understood to be a validation step that limits the range of values between, for example, −99% to 99%.

The method for selectively adjusting a price may also include a step 306 of assigning an actual price adjustment percentage for predefined increments of the numerical growth rate percentages derived for each of the inventor SKUs. The actual price adjustment percentages at each increment may be assigned according to a transition type that is likewise specified via the first interface panel 42a. As shown in FIG. 6, there is a first selectable option 50a corresponding to a smooth transition that applies a gradual change in actual adjustment percentages for inventory SKUs 26 with numerical growth rate percentages between the upper and lower thresholds. Additionally, there is a second selectable option 50b corresponding to a precise transition, in which exact percentages as specified for each growth trend classification are assigned.

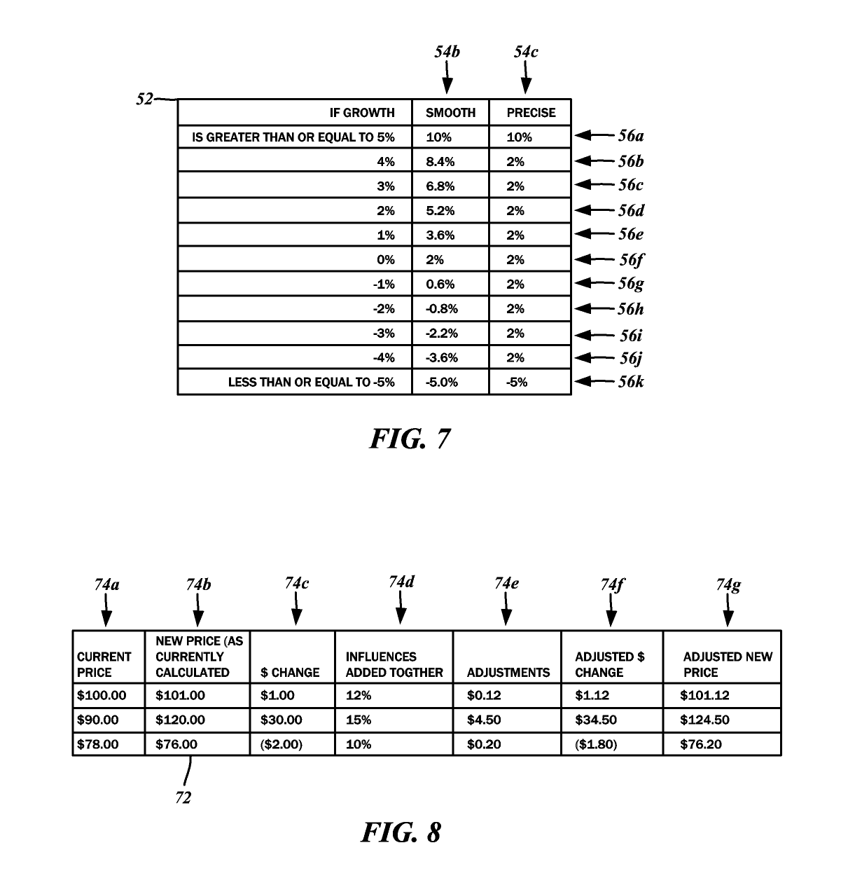

In the illustrated example shown in FIG. 6, the increasing growth trend classification specifies the application of a 10% categorical adjustment percentage, the flat growth trend classification specifies the application of a 2% categorical adjustment percentage, and the decreasing growth trend classification specifies the application of a −5% categorical adjustment percentage. As shown in table 52 of FIG. 7, the range of possible growth rate percentages for each classification of growth trends is shown in a first column 54a, starting from the upper threshold of 5% to the lower threshold of −5%, by way of example. For a given inventory SKU 26 that has an increasing growth trend classification, i.e., a numerical growth rate percentage that is greater than or equal to the upper threshold, a 10% actual adjustment percentage is applied thereto. This is true for a growth rate percentage of 5% for both the smooth transition, shown in a second column 54b, and the precise transition, as shown in a third column 54c. For an inventory SKU 26 that has a decreasing growth trend classification, i.e., a numerical growth rate percentage that is less than or equal to the lower threshold, a −5% adjustment percentage is applied thereto. Again, for both the smooth transition and the precise transition, as shown in row 56k, a −5% actual adjustment percentage is designated to be applied. When the precise transition is specified, as indicated in rows 56b-56j in the third column 54c, for each percentage increment between the low end threshold of −5% and the high end threshold of 5%, the specified 2% actual adjustment percentage is to be applied.

With the smooth transition, however, a different actual adjustment percentage is derived for each percentage increment. Continuing with the example of the high end threshold of 5%, the low end threshold of −5%, and a default 0% flat growth rate center, there is understood to be five percentage increments for the transition between the 2% actual adjustment percentage corresponding to the flat growth rate trend and the 10% actual percentage adjustment for the increasing growth rate trend. Thus, each increment must change by 1.6%, as follows: (10%−2%)/5%. Similarly, there are five percentage increments form the transition between the 2% actual adjustment percentage for the flat growth rate trend and the −5% actual percentage adjustment for the decreasing growth rate trend. Each increment therefore changes by −1.4% as follows: (−5%−2%)/5%.

Besides the foregoing unit growth trend influence, as shown in FIG. 6, other influences on the final price adjustment may be defined. These may be generally referred to as predefined elasticit influence categories. In the elasticity influence configuration window 44, there is a second interface panel 42b. Referring back to the data structure diagram of FIG. 2, each inventory SKU 26 is also understood to have a markup value 60, which represents the difference between the cost of the item as may be set forth in a cost value 62 likewise stored in the specific inventory SKU 26, and the price for which it is sold, e.g., the original price value 32. Depending on the specifics of the product, vastly different markups may be applied. Via the second interface panel 42b, each inventory SKU 26 may be assigned to one of a predefined number of markup categories, with various actual price adjustment percentages being assigned depending on the applicable category. With the addition of another actual price adjustment percentage specific to mark-ups, it is understood that there are two actual price adjustment percentages being handled—one for the unit growth trend influence, and the other for the mark-ups. Where relevant, reference will be made to a first actual price adjustment percentage and a second actual price adjustment percentage. However, usage herein of the modifier “first” and “second” is for differentiation purposes only, and not of limitation.

As shown in the example, there is a first markup group of 78% to 320%, and inventory SKUs 26 having the markup value 60 falling within those ranges will be assigned a second actual price adjustment percentage of 0%. There is a second markup group of 66% to 77%, which has an associated 5% second actual price adjustment percentage, as well as a third markup group of 51% to 36% with a 10% second actual price adjustment percentage. Finally, there is a fourth markup group of 20% to 35% with a 15% second actual price adjustment percentage. The number of groups is variable and may be specified via an input element 64a. Again, because there are wide variations between mark-ups, some limits as to lower and upper outliers can be defined via input elements 64b, 64c. The application of the mark-up influence to the price adjustment may be selectively activated and deactivated via the same include checkbox 46.

Similar categorical assignment of second actual price adjustment percentages to each inventory SKU 26 is possible with the inventory days on hand. The general objective for evaluating the level of availability for a product is to increase prices as it lowers, and decrease as it rises; it will be appreciated that lower prices typically stimulate demand and works to lower inventory days on hand, while higher prices typically works opposite. This data is also understood to be associated with each inventory SKU 26, which may include a days on hand value. Like the second interface panel 42b, a third interface panel 42c specific to the days on hand influence also includes input elements 64 defining the number of groups or categories and the lower and upper outliers. Each of the groups may be assigned second actual price adjustment percentages.

For inventory SKUs 26 that are not currently stocked by the seller, the expected lead time may play a role in pricing strategy. For example, products that are difficult to procure may be priced differently than products that are easier to procure. Typically twelve months of purchasing transaction history is needed to determine a lead time value 70, and is based on the date a particular order was placed with the vendor or supplier, the actual receipt date, an SKU identifier, the quantity ordered, and the identity of the vendor. With multiple orders, the average delay between order date and receipt date can be determined. Again, as with the other influences, the inventory SKUs 26 may be categorized according to groups of lead times, with different second actual price adjustment percentages being assigned depending on the group. Configuring the variables of such operations is possible via a fourth interface panel 42d. The number of groups or categories, as well as the two outlier boundaries, may be specified via the input elements 64.

Regardless of the specifics of elasticity influence, the method for re-pricing contemplates a step of assigning each of the inventory SKUs 26 to a one of a plurality of predefined elasticity influence categories based upon associated first elasticity influence values. Each elasticity influence category has an associated price adjustment percentage.

As indicated above, the presently contemplated method may be a supplemental adjustment to a movement or sales volume segmenting based re-pricing methods as described in the aforementioned application Ser. Nos. 13/043,285 and 13/540,360. The actual percentage adjustments generated in accordance with the techniques disclosed herein are understood to be further changes to the prices derived from those methods. In this regard, reference to the original price value in the context of the presently disclosed method for adjusting a price is understood to encompass any previously applied pricing optimizations. However, it is understood that re-pricing functions may also be standalone as well.

Referring back to the flowchart of FIG. 3, the method continues with a step 308 of generating a revised price value for each of the inventory SKUs based upon the corresponding actual price adjustment percentage described above. To the extent there are multiple actual price adjustment percentages for the various influences such as mark-up, days on hand, and lead time, these are aggregated into a single actual price adjustment percentage. After the product movement based re-pricing methods generate an optimized price, the actual price adjustment percentage is applied thereto. With reference to table 72 of FIG. 8, a first column 74a lists exemplary original price values 32 arranged according to inventory SKUs 26 by rows 76a-76c. After the movement-based pricing optimizations are performed, a set of corresponding new prices are generated, as shown in column 74b. The difference between the old, un-optimized price and the new optimized price is shown in column 74c. Each of the aforementioned influences, i.e., the actual price adjustment percentages from the movement, mark-up, days on hand, and lead time, to the extent they are activated via the include checkbox 46, are summed as listed in column 74d. Next, the adjustment amount is generated from the absolute value of the difference between the old price and the new price, as shown in column 74e. Where there are negative values for the difference, the adjustment amount is nevertheless specified in positive values. The adjustment amount is added back to the difference between the old price and the new price to yield an adjusted difference shown in column 74f. This, in turn, is added back to the old price to yield an adjusted new price shown in column 74g.

The adjusted new prices may over-write the existing values of the original price values 32 and saved to the inventory database 12. Additionally, various reports showing the adjustments may be produced.

The particulars shown herein are by way of example and for purposes of illustrative discussion of the embodiments of the present disclosure only and are presented in the cause of providing what is believed to be the most useful and readily understood description of the principles and conceptual aspects of the inventory re-pricing methods. In this regard, no attempt is made to show more details than is necessary for a fundamental understanding of the disclosure, the description taken with the drawings making apparent to those skilled in the art how the several forms of the presently disclosed methods may be embodied in practice.

What is claimed is:

1. A method for selectively adjusting a price associated with an inventory stock keeping unit (SKU) stored in a catalog database of a plurality of inventory SKUs, the method comprising:
retrieving at least a subset of the plurality of inventory SKUs in the catalog database, each of the retrieved inventory SKUs having associated therewith one or more sales transaction history records and an original price value;
deriving for each of the inventory SKUs a numerical growth rate percentage and a growth trend corresponding to one of one or more classifications based upon the retrieved sales transaction history records;
receiving categorical price adjustment percentages for the one or more classifications of growth trends;
assigning an actual price adjustment percentage for predefined increments of the numerical growth rate percentages derived for each of the inventory SKUs; and
generating a revised price value for each of the inventory SKUs based upon the corresponding actual price adjustment percentage for the associated numerical growth rate percentage thereof.

2. The method of claim 1, wherein the sales transaction history records includes an SKU identifier, a sale date, a sale quantity corresponding to the sale date, and a quantity unit identifier for the sale quantity.

3. The method of claim 1, wherein the sales transaction history records includes an SKU identifier, a sale month, a sale year, a sale quantity summary for the sale month and the sale year, and a quantity unit identifier for the sale quantity summary.

4. The method of claim 1, wherein sales transaction history records span at least three years of sales activity.

5. The method of claim 1, wherein deriving the growth trend includes:
retrieving a seasonal index and a seasonal sensitivity value specific to the inventory SKUs from an external source;
comparing the numerical growth rate percentage to a low end threshold and a high end threshold based on the seasonal index and seasonal sensitivity values; and
assigning an increasing growth trend classification to the growth trend if the numerical growth rate is greater than or equal to the high end threshold, a decreasing growth trend classification if the numerical growth rate is less than or equal to the low end threshold, and a flat growth trend classification if the numerical growth rate is between the low end threshold and the high end threshold.

6. The method of claim 5, wherein a price adjustment range is received for each of the increasing growth trend classification, the flat growth trend classification, and the decreasing growth trend classification.

7. The method of claim 1, wherein the actual price adjustment percentages at each increment are assigned according to a transition type.

8. The method of claim 7, wherein the transition type is precise, and the actual price adjustment percentages change at growth rate percentages of growth trend classification thresholds.

9. The method of claim 7, wherein the transition type is smooth, and the actual price adjustment percentages change at each predefined percentage increment over a range of growth rate percentages for the inventory SKUs.

10. The method of claim 1, further comprising:
assigning the respective revised price values to each of the inventory SKUs for storage in the catalog database.

11. The method of claim 1, wherein each of the plurality of inventory SKUs in the catalog database has associated therewith a markup percentage value.

12. The method of claim 11, further comprising:
assigning each of the retrieved inventory SKUs to a one of a plurality of predefined markup categories based upon the associated markup percentage value, each of the predefined markup categories having a corresponding price adjustment percentage.
deriving price change values between the original price value and the revised price value for each of the retrieved inventory SKUs;
generating an adjusted price change for each of the retrieved inventory SKUs by applying the corresponding price adjustment percentage to the price change values;
generating a second revised price value for each of the inventory SKUs based upon the corresponding adjusted price change.

13. The method of claim 1, wherein each of the plurality of inventory SKUs in the catalog database has associated therewith an inventory days on hand value.

14. The method of claim 13, further comprising:
assigning each of the retrieved inventory SKUs to a one of a plurality of predefined inventory days on hand categories based upon the associated inventory days on hand value, each of the predefined inventory days on hand categories having a corresponding price adjustment percentage;
deriving price change values between the original price value and the revised price value for each of the retrieved inventory SKUs;
generating an adjusted price change for each of the retrieved inventory SKUs by applying the corresponding price adjustment percentage to the price change values; and
generating a second revised price value for each of the inventory SKUs based upon the corresponding adjusted price change.

15. The method of claim 1, wherein each of the plurality of inventory SKUs in the catalog database has associated therewith an SKU lead time value.

16. The method of claim 15, further comprising:
assigning each of the retrieved inventory SKUs to a one of a plurality of predefined SKU lead time categories based upon the associated SKU lead time value, each of the predefined SKU lead time categories having a corresponding price adjustment percentage;
deriving price change values between the original price value and the revised price value for each of the retrieved inventory SKUs;
generating an adjusted price change for each of the retrieved inventory SKUs by applying the corresponding price adjustment percentage to the price change values;
generating a second revised price value for each of the inventory SKUs based upon the corresponding adjusted price change.

17. An article of manufacture comprising a program storage medium readable by a data processing apparatus, the medium tangibly embodying one or more programs of instructions executable by the data processing apparatus to perform a method for selectively adjusting a price associated with an inventory stock keeping unit (SKU) stored in a catalog database of a plurality of inventory SKUs, the method comprising:
retrieving at least a subset of the plurality of inventory SKUs in the catalog database, each of the retrieved inventory SKUs having associated therewith one or more sales transaction history records and an original price value;
deriving for each of the inventory SKUs a numerical growth rate percentage and a growth trend corresponding to one of one or more classifications based upon the retrieved sales transaction history records;
receiving categorical price adjustment percentages for the one or more classifications of growth trends;
assigning an actual price adjustment percentage for predefined increments of the numerical growth rate percentages derived for each of the inventory SKUs;
generating a revised price value for each of the inventory SKUs based upon the corresponding actual price adjustment percentage for the associated numerical growth rate percentage thereof; and
assigning the respective revised price values to each of the inventory SKUs for storage in the catalog database.

18. A method for selectively adjusting a price associated with an inventory stock keeping unit (SKU) stored in a catalog database of a plurality of inventory SKUs, the method comprising:
retrieving at least a subset of the plurality of inventory SKUs in the catalog database, each of the retrieved inventory SKUs having associated therewith one or more sales transaction history records and an original price value;
deriving for each of the inventory SKUs a numerical growth rate percentage and a growth trend corresponding to one of one or more classifications based upon the retrieved sales transaction history records;
receiving categorical price adjustment percentages for the one or more classifications of growth trends;
assigning an actual price adjustment percentage for predefined increments of the numerical growth rate percentages derived for each of the inventory SKUs;
generating a revised price value for each of the inventory SKUs based upon the corresponding actual price adjustment percentage for the associated numerical growth rate percentage thereof;
assigning each of the retrieved inventory SKUs to a one of a plurality of first predefined elasticity influence categories based upon associated first elasticity influence values, each of the predefined first elasticity influence categories having a corresponding first price adjustment percentage;
deriving price change values between the original price value and the revised price value for each of the retrieved inventory SKUs;
generating an adjusted price change for each of the retrieved inventory SKUs by applying a corresponding aggregate price adjustment percentage including the first price adjustment percentage to the price change values; and
generating a second revised price value for each of the inventory SKUs based upon the corresponding adjusted price change.

19. The method of claim 18, wherein the first predefined elasticity influence categories are predefined markup percentage categories and the first elasticity influence values are markup percentage values.

20. The method of claim 18, wherein the first predefined elasticity influence categories are predefined inventory days on hand categories and the first elasticity influence values are inventory days on hand values.

21. The method of claim 18, wherein the first predefined elasticity influence categories are SKU lead time categories and the first elasticity influence values are SKU lead time values.

22. The method of claim 15, further comprising:
assigning each of the retrieved inventory SKUs to a one of a plurality of second predefined elasticity influence categories based upon associated second elasticity influence values, each of the predefined second elasticity influence categories having a second corresponding price adjustment percentage;
wherein the aggregate price adjustment percentage for a given inventory SKU includes the second price adjustment percentage.
